(19) United States
(12) Patent Application Publication
(10) Pub. No.: US 2004/0253394 A1
(43) Pub. Date: Dec. 16, 2004

(54) Package of ink-jet recording sheets and ink-jet recording method

(75) Inventors: Harue Ebisawa, Tokyo (JP); Yukako Taka, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Minolta Photo Imaging, Inc., Tokyo (JP)

(21) Appl. No.: 10/859,785

(22) Filed: Jun. 3, 2004

(30) Foreign Application Priority Data
Jun. 11, 2003 (JP) JP2003-166260

(51) Int. Cl. B41M 5/00

(52) U.S. Cl. 428/32.24; 428/32.1

(57) ABSTRACT

A package comprising: (i) a plurality of ink-jet recording sheets stacked one on top of the other, wherein each of said ink-jet recording sheet has an ink receptive layer as a top layer; (ii) a protective sheet which is placed on a top ink-jet recording sheet of said plurality of ink-jet recording sheet, said protective sheet having a water-resistant surface, said water-resistant surface facing said ink receptive layer of said top ink-jet recording sheet, wherein said water-resistant surface has a center-line mean roughness (Ra) of 0.2-3 μm measured based on JIS B 0601 with a reference length of 2.5 mm and a cut-off value of 0.8 mm; and (iii) an envelop sheet surrounding said plurality of ink-jet recording sheets and said protective sheet thereby forming said package.

### TECHNICAL FIELD

The present invention relates to a package of high quality ink-jet recording sheets, and specifically to a package of ink-jet recording sheets which minimizes degradation of physical characteristics of the outermost ink-jet recording sheet stacked in the package even in the case of storage over an extended period of time.

### BACKGROUND

Regarding ink-jet recording sheets in sheet form, a plurality of ink-jet recording sheets, which comprise a support having thereon an ink receptive layer, is stacked and enclosed in an envelop sheet such as a resinous film, a paper bag, or a paper box. Further, these packages are packaged by outer packaging materials such as a corrugated cardboard box and then shipped.

Specifically, for the purpose of minimizing physical problems due to varying factors such as surface friction and applied pressure during the production process, distribution and display at shops, a protective sheet is commonly used on the surface of the outermost ink-jet recording sheet of the stacked ones.

Heretofore, commonly employed as protective sheets have been relatively thick paper sheets (for example, 150-500 μm). Various additives are used on the surface of ink-jet recording sheets so that colorants are quickly fixed via quick absorption of ink. When the ink-jet recording sheets were stored over an extended period of time while brought into close contact with a protective sheet of which surface was comprised of paper, it was discovered that undesirable problems gradually occurred on the surface of the outermost (or called as the top) ink-jet recording sheet.

The first of such problems includes a case in which surface whiteness of the outermost ink-jet recording sheet gradually deteriorates. This results as follows. Commonly incorporated into an ink receptive layer are dye fixing agents. However, various additives incorporated into the protective sheet gradually diffuse into the ink receptive layer during storage over an extended period of time. Diffusing substances themselves are colored and colored substances are formed upon reacting with other substances incorporated into the ink receptive layers, whereby whiteness gradually deteriorates.

The second problem is that the surface state of the outermost ink-jet recording sheet results in slight variation of glossiness and roughness, also during storage over an extended period of time, depending on the type of protective sheets. This problem depends on the surface characteristics of ink-jet recording sheets and tends to occur more when the glossiness is relatively high. Namely, when the ink-jet recording sheets are stored for an extended period time while brought into close contact with a protective sheet comprised of common paper, the surface which comes into contact with the protective sheet tends to decrease in glossiness.

The above-mentioned problem tends to occur in the following case due to an increase in a degree of close contact between the protective sheet and the ink-jet recording paper. Ink-jet recording sheets are sealed in a resinous bag together with a protective sheet, and a plurality of bags is stacked and stored for an extended period of time. It is not preferable that whiteness and glossiness of the outermost recording sheet are different from those of the second and following sheets.

In order to protect the surface of the outermost ink receptive layer of ink-jet recording materials, a package of ink-jet recording sheets is described (refer, for example, to Patent Document 1) which employs a water-resistant protective sheet. Further, it describes a package of ink-jet recording sheets in which difference in color between the outermost recording sheet and the following recording sheets decreases.

The inventor of the present invention investigated a package of such recording sheets. As a result, it was discovered that of the above-mentioned problems, by employing a water-resistant protective sheet, deviation of image tone as well as variation of white background due to storage was markedly decreased.

On the other hand, however, it was noted that variation of glossiness of the outermost sheet was not effectively minimized, and on the contrary, the variation sometimes increased.

Namely, in the case in which a resin-treated protective sheet of high surface glossiness was used, the following were discovered. Glossiness of the above-mentioned protective sheet occasionally increased the glossiness of the outermost ink receptive layer. Further, in the case in which glossiness of the protective sheet was excessively low, on the contrary, glossiness of the surface of the outermost ink receptive layer tended to decrease.

Specifically, when ink employed during ink-jet recording is a pigment ink, problems tend to occur since delicate glare generated on prints which result in subtle roughness on the surface markedly affects the glossiness.

(Patent Document 1)

Japanese Patent Publication Open to Public Inspection (hereinafter referred to as JP-A) No. 2002-255235

### SUMMARY OF THE INVENTION

An object of the present invention is to provide a package of ink-jet recording sheets in which variation of white background and glossiness of the surface of the ink receptive layer of the outermost ink-jet recording sheet is reduced even in the case of storage over an extended period of time. Further, another object of the present invention is to provide an ink-jet recording method using these ink-jet recording sheets.

One aspect of the present invention includes a package comprising:

(i) a plurality of ink-jet recording sheets stacked one on top of the other, wherein each of said ink-jet recording sheet has an ink receptive layer as a top layer;

(ii) a protective sheet which is placed on a top ink-jet recording sheet of said plurality of ink-jet recording sheet, said protective sheet having a water-resistant surface, said water-resistant surface facing said ink receptive layer of said top ink-jet recording sheet,

wherein said water-resistant surface has a center-line mean roughness (Ra) of 0.2-3 μm measured based on JIS B 0601 with a reference length of 2.5 mm and a cut-off value of 0.8 mm; and

(iii) an envelop sheet surrounding said plurality of ink-jet recording sheets and said protective sheet thereby forming said package.

The above objects of the present invention are also achieved employing the embodiments described below.

### BRIEF DESCRIPTION OF DRAWINGS

FIG. 1 is a schematic cross-section of the package of the present invention.

### DETAILED DESCRIPTION OF PREFERRED EMBODIMENTS

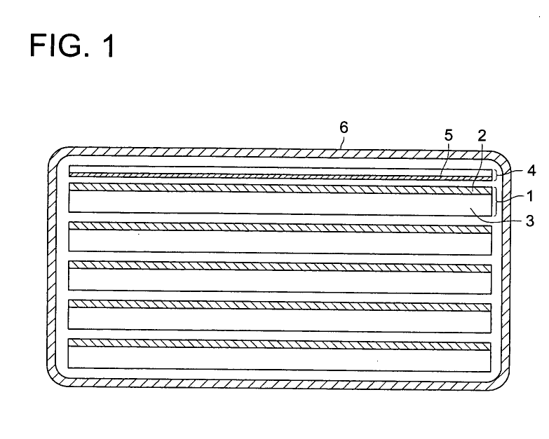

The present invention can be described by using FIG. 1. Number 1 indicates an ink-jet recording sheet. Number 2 indicates an ink receptive layer of the ink-jet recording sheet. Number 3 indicates a substrate of the ink-jet recording sheet. Number 4 indicates a protective sheet. Number 5 indicates a surface of the protective sheet. Number 6 indicates an envelop sheet surrounding a plurality of ink-jet recording sheets and the protective sheet resulting in forming a package.

Another aspect of the present invention includes the above-described package, wherein the water-resistant surface of the protective sheet is made by applying a surface layer forming composition containing a water-resistant resin on the paper support or laminating a film containing the water-resistant resin on the paper support.

Another aspect of the present invention includes the above-described package, wherein the water-resistant resin is a polyolefin resin and the surface layer has a thickness of 2 to 50 μm.

Another aspect of the present invention includes the above-described package, wherein the center-line mean roughness (Ra) of the water-resistant surface of the protective sheet and an center-line mean roughness (Ra′) of a surface of the ink receptive layer of the ink-jet recording sheet satisfy the following formula:

|Ra−Ra′|≦1 μm

Another aspect of the present invention includes the above-described package, wherein the ink-jet recording sheet comprises:

(i) a resin coated paper having on both sides thereof a polyolefin resin layer; and

(ii) an ink receptive layer containing inorganic microparticles and a hydrophilic polymer on one side of the polyolefin resin layer.

Another aspect of the present invention includes a method of forming an image comprising a step of ejecting droplets of ink on an ink-jet recording sheet with an ink-jet printer,

wherein the ink-jet recording sheet is packed in the above-described package.

Another aspect of the present invention includes a method of forming an image, wherein the ink is a water-based pigment ink.

The present invention is further detailed below.

A paper substrate of the protective sheet is made mainly of natural pulp. The thickness of the paper differs depending on whether other protective sheets are simultaneously employed or not. When other protective sheets are not simultaneously employed, the aforesaid thickness is commonly 150-1,000 μm, and is preferably 200-500 μm. When other protective sheets are simultaneously employed, it is possible to use a thinner paper, for example, at a thickness of 50-300 μm.

The aforesaid paper may be either coated paper or recycled paper.

Methods to waterproof at least one side of the aforesaid paper include coating of waterproof resins and lamination of waterproof resinous film. It is possible to waterproof either one or both sides of the paper. However, in view of workability and insertion between ink-jet recording sheets, it is preferable to waterproof both sides.

Employed as waterproofing resins used may be olefin based homopolymers and copolymers such as polyethylene, polypropylene, polybutene, polypentene, or ethylene-propylene copolymers, or copolymers of these olefins with other monomers having unsaturated bonds (for example, vinyl acetate, styrene, vinyl chloride, acryl based monomers), polyesters, acetate resins acrylamide resins, and polyimide resins. Of these, in view of cost and workability, preferred are olefin based homopolymers and copolymers, or copolymers (hereinafter referred to as olefin based resins) of olefins with other monomers having unsaturated bonds.

These waterproofing resins are applied preferably onto both sides of the paper preferably employing an appropriate coating method. During that process, in view of adhesion property, it is preferable that the surface of the paper substrate is activated by a corona treatment or a plasma treatment.

The water-resistant surface may be subjected to post-treatments such as antistatic and water-repellent treatments. The aforesaid surface may be treated, for example, with quaternary ammonium based surface active agents, various hydrophilic polymers, fluorine containing compounds, waxes, and various silicone oils, and the treatments are carried out on the surface of the ink receptive layer within a range which does not adversely affect the recording characteristics.

In the present invention, it is required that the center line mean roughness (Ra) of the water-resistant surface of the protective sheet is 0.2-3 μm when determined at a reference length of 2.5 mm and a cut-off value of 0.8 mm as specified in JIS B 0601.

The International standards corresponding to JIS B 0601 are as follows: ISO 468-1982, ISO 3274-1975, ISO 4287/1-1984, ISO-4287/2-1984 and ISO 4288-1985.

When Ra is less than 0.2 μm, the smoothness of the surface which comes into contact with the surface of the ink receptive layer of the protective sheet increases. Consequently, the glossiness of the surface of the ink receptive layer tends to increase during storage over an extended period of time. On the other hand, when Ra exceeds 3 μm, the roughness of the surface of the protective sheet tends to be transferred to the surface of the ink receptive layer.

When an ink-jet recording sheet is used as a glossy paper, 60-degree specular glossiness of the surface of the ink receptive layer is commonly at least 30 percent, determined based on JIS Z 8741. For such a recording sheet, a protective sheet at surface roughness Ra of 0.2-2 μm is particularly preferred.

On the other hand, in the case of recording sheets which have a embossed surface such as a silk or semi-matte finish, the glossiness of the ink receptive layer is about 20-about 40 percent. It is preferable that protective sheets of an Ra of 0.3-3 μm are used.

Due to the above, it is particularly preferred that the difference between the center line mean roughness (Ra) of the water-resistant surface of a protective sheet, and the center line mean roughness (Ra′) of the surface of the ink receptive layer of an outermost ink-jet recording sheet, which comes into contact with the aforesaid surface, is |Ra−Ra′|≦1 μm.

The thickness of the water-resistant layer of the protective sheet is preferably at least 2 μm. When it is less than 2 μm, it tends to not result in discoloration retarding effects of the white background of the ink receptive layer of the outermost recording sheet during storage. The thickness of the water-resistant layer of the protective sheet is more preferably at least 5 μm.

The upper limit of the thickness of the water-resistant layer of the protective sheet is not specifically determined, however, by considering the production cost, it is around not more than 50 μm.

Any of the ink-jet recording sheets in the form of a sheet of the present invention may be employed as long as they are in the form of a common sheet. Generally, any of sheets in the range of a size from a business card (about 5.5×about 9 cm) to A2 enlarged (about 65×about 80 cm) may be employed. It is preferable that the size of protective sheets is substantially the same as recording sheets.

Further, the number of sheets enclosed in a single package is approximately 2-1,000. A protective sheet is enclosed to be brought into contact with the surface of the ink receptive layer of the outermost recording sheet enclosed in the above-mentioned package. However, the protective sheet may be enclosed at another position such as a position, between ink-jet recording sheets.

In the package of ink-jet recording sheets of the present invention, other than the water-resistant protective sheet at the specified roughness as noted above, it is possible to use another kind of a protective sheet, for example, comprised of paper. However, in this case, it is required that the surface of the protective sheet which comes into contact with the ink receptive layer of the outermost recording sheet is water-resistant and has a roughness range specified in the present invention.

A plurality of stacked ink-jet recording sheets in the form of a sheet in which the surface is protected by the above-mentioned protective sheet is packaged employing a packaging material (also called as an envelop in the present invention). The surface of the ink receptive layer of many ink-jet recording sheets tends to be discolored by oxygen and oxidizing gases. Therefore, it is preferable that ink-jet recording sheets are packaged employing packaging materials such as plastic resinous film at a relatively low oxygen permeability. Employed as such plastic resinous films may be, for example, various films comprised of polyethylene, polypropylene, polycarbonate, and polyester. The thickness of these films is preferably about 20-about 80 μm. Further, if required, package(s) of ink-jet recording sheets are packed employing a paperboard box or a corrugated paperboard box.

Ink-jet recording sheets will now be described.

Ink-jet recording sheets comprise a support having thereon at least one ink receptive layer.

Employed as supports may be either a water absorptive support or a non-water absorptive support. However, the non-water absorptive support is preferred due to absence of wrinkling.

Represented as water absorptive supports are those particularly comprised of natural pulp. However, also employed may be those comprised of a mixture of synthetic pulp and natural pulp.

Listed as non-water absorptive supports are plastic resinous film supports as well as supports coated on both sides with plastic resins.

Listed as plastic resinous film supports are polyester film, polyvinyl chloride film, polypropylene film, cellulose triacetate film, and polystyrene film, cellulose triacetate film, and polystyrene film.

In the present invention, supports which are prepared by coating both sides of paper with polyolefin resins are most preferred.

The most preferred supports which are prepared by coating both sides of paper with polyolefin resins will now be described.

Paper employed for the supports of the present invention is made of wood pulp as the main raw material, and if desired, employing synthetic pulp such as polypropylene, or synthetic fiber such as nylon or polyester in addition to wood pulp. As wood pulp, any of, for example, LBKP, LBSP, NBKP, NBSP, LDP, NDP, LUKP, and NUKP may be employed. However, it is preferable that LBKP, LBSP, NDP, and LDP comprising a large amount of short fiber portions are employed in a larger amount. In such a case, the ratio of LBSP and/or LDP is preferably 10-70 percent by weight.

As the above-mentioned pulp, chemical pulp (sulfate salt pulp and sulfite pulp), containing minimal impurities, is preferably employed, and pulp, which is subjected to bleaching treatment to increase whiteness, is also beneficial.

Suitably incorporated into paper may be sizing agents such as higher fatty acids or alkylketene dimers, white pigments such as calcium carbonate, talc, or titanium oxide, paper strength enhancing agents such as starch, polyacrylamides, or polyvinyl alcohol, optical brightening agents, humectants such as polyethylene glycol, dispersing agents, and softening agents such as quaternary ammonium.

The freeness of pulp employed for paper making is preferably 200-500 ml under the CSF specification. Further, regarding fiber length after beating, the sum of the 24 mesh residue and the 42 mesh residue, specified in JIS P 8207, is preferably 30-70 percent. Incidentally, 4 mesh residue is preferably at most 20 percent.

The basic weight of paper is preferably 50-250 g, and is particularly preferably 70-220 g, while the thickness of paper is preferably 50-220 μm.

Paper of high smoothness may result by employing calender finishing during or after paper making. The density of paper is customarily 0.7-1.2 g/cm² (JIS P 8118). Further, the stiffness of paper is preferably 20-300 g under conditions specified by JIS P 8143.

Surface sizing agents may be applied onto the surface of paper. Employed as surface sizing agents may be the same ones as those which can be incorporated into base paper.

The pH of paper, when determined by the hot water extraction method specified in JIS P 8113, is preferably 5-9.

Polyethylene resins which are employed for coating both sides of paper will now be described.

Preferred as polyolefin resins employed for the aforesaid purpose are polyolefins such as polyethylene, polypropylene, polyisobutylene, or copolymers comprised of ethylene or propylene as a main component. Of these, polyethylene is particularly preferred.

Particularly preferred polyethylene will be described.

Polyethylene which is employed for coating both sides of paper is mainly comprised of low density polyethylene (LDPE) and/or high density polyethylene (HDPE). However, it is possible to partly use LLDPE and polypropylene.

It is preferable that opacity and whiteness of the polyethylene layer on the coating layer side are improved by incorporation of anatase type titanium dioxide. The proportion of titanium oxide is customarily 3-20 percent by weight with respect to polyethylene, and is preferably 4-13 percent by weight.

In order to control the white background, it is possible to incorporate pigments and optical brightening agents with high heat resistance into the polyolefin layer.

Listed as colored pigments are, for example, ultramarine blue, Prussian blue, cobalt blue, phthalocyanine blue, manganese blue, cerulean blue, tungsten blue, molybdenum blue, and anthraquinone blue.

Listed as optical brightening agents are, for example, dialkylaminocoumarin, bisdimethylaminostilbene, bismethylaminostilbene, bisbenzoxazolylethylene, and dialkylstilbene.

The amount of polyethylene used on both sides of paper is selected so that curling at low and high humidity is optimized after determining the thickness of the ink receptive layer as well as providing a back layer. However, the thickness of the polyethylene layer on the ink receptive layer coating side is customarily 15-40 μm, while that on the back layer coating side is customarily 10-30 μm.

Further, it is preferable that the aforesaid polyolefin coated paper supports exhibit the following characteristics.

(1) Tensile strength: Strength specified in JIS P 8113 is preferably 20-300 N in the longitudinal direction and 10-200 N in the lateral direction.

(2) Tear strength: Strength specified in JIS P 8116 is preferably 0.1-20 N in the longitudinal direction and 0.2-20 N in the lateral direction.

(3) Compression modulus of elasticity is preferably at least 98 MPa N/cm.

(4) Opacity is customarily at least 80 percent and particularly preferably at least 85 percent when determined employing the method specified in JIS P 8138.

(5) Whiteness L*, a*, and b* specified in JIS Z 8729 are preferably from 80 to 95, from −3 to +5, and from −7 to +2, respectively.

(6) Clark stiffness: Supports are preferred which result in a Clark stiffness of the recording sheet in the conveying direction of 50-300 cm³/100.

(7) Moisture in base paper is preferably 4-10 percent by weight with respect to the core paper.

(8) Glossiness of base paper: Even though not particularly specified, in the case of glossy surface base paper, glossiness is preferably 30-80 percent, while in the case of embossed base paper, glossiness is preferably 7-50 percent.

An ink receptive layer provided on a support will now be described. The ink receptive layer may be provided only on one side or on both sides of the support. At that time, ink receptive layers provided on both sides may be the same or different.

In the case of recording sheets comprising an ink receptive layer on both sides, it is preferable that the protective sheet of the present invention is arranged so that the water-resistant surface comes into contact with the uppermost ink receptive layer of the top and the bottom.

Ink receptive layers are divided mainly into a swelling layer type ink receptive layer and a void type ink receptive layer.

The swelling type ink receptive layer is comprised of hydrophilic polymers which can be swelled in ink solvents. Listed as such hydrophilic polymers are gelatin (alkali process gelatin, acid process gelatin, and gelatin derivatives in which the amino group is blocked by phenyl isocyanate or phthalic anhydride), polyvinyl alcohol (preferably of an average degree of polymerization of 300-4,000 and a saponification ratio of 80-99.5 percent), polyvinylpyrrolidone, polyethylene oxides, hydroxyethylcellulose, agar, Pullulan, dextran, acrylic acid, carboxymethylcellulose, casein, and alginic acid. These may be employed in combinations of at least two types.

Minute particles such as minute inorganic particles and minute organic particles may be incorporated into the swelling type ink receptive layer in an amount range which does not adversely affect swellability of hydrophilic polymers. The above-mentioned amount is customarily at most 100 percent by weight.

The amount of hydrophilic polymers used in the swelling layer is commonly 3-20 g per m² of the recording sheet, and is preferably 5-15 g.

The void type ink receptive layer is preferably a porous layer comprised of a void layer comprising minute inorganic particles (or called as inorganic microparticles) as well as a small amount of hydrophilic polymers.

Listed as such minute inorganic particles may be, for example, white inorganic pigments such as precipitated calcium carbonate, calcium carbonate heavy, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthetic non-crystalline silica, colloidal silica, alumina, colloidal alumina, pseudo-boehmite, aluminum hydroxide, lithopone, zeolite, or magnesium hydroxide.

Such minute inorganic particles may be employed in the form of primary particles without any modification or in a state in which secondary aggregated particles are formed.

In the present invention, in view of achieving efficient color formation, silica or pseudo-boehmite is preferred. Specifically, preferred are silica particles at an average particle diameter of at most 100 nm, which are synthesized employing a gas phase method, colloidal silica, and pseudo-boehmite. Further, most preferred is silica particles at an average particle diameter of at most 100 nm, which are synthesized employing a gas phase method.

The average diameter of minute inorganic particles is determined as follows. Particles themselves or the cross-section and surface of a void layer are observed employing an electron microscope, and the diameters of 100 randomly selected particles are determined. Subsequently, the aforesaid average diameter (being a number average) is obtained by simply averaging the resulting values. Herein, each particle diameter is represented by the diameter of a circle which has the same area as the projected area of the aforesaid particle.

Employed as hydrophilic polymers used in the void layer are those which are the same as those employed in the swelling type ink receptive layer. Of these, preferred is polyvinyl alcohol. The ratio of minute inorganic particles to the hydrophilic polymers is preferably 2:1-20:1, and is more preferably 3:1-10:1.

Polyvinyl alcohols preferably employed in the present invention include common polyvinyl alcohol prepared by hydrolyzing polyvinyl acetate, and in addition, modified polyvinyl alcohol such as cation-modified polyvinyl alcohol at the terminal as well as anion-modified polyvinyl alcohol having an anionic group.

Polyvinyl alcohols of an average degree of polymerization of at least 300, which are prepared by hydrolyzing vinyl acetate, are preferably employed and those of an average degree of polymerization of 1,000-5,000 are particularly preferably employed.

Those of a saponification ratio of 70-100 percent are preferred and those of a saponification ratio of 80-99.5 percent are particularly preferred.

Further, in the case in which the aforementioned void layer comprises polyvinyl alcohol as a hydrophilic polymer, in order to improve filming property of a layer and enhance strength of a layer, it is preferable that boric acids or salts thereof are incorporated.

Boric acids and salts thereof refer to oxygen acids having a boron atom as a central atom and salts thereof, and specifically include orthoboric acid, metaboric acid, hypoboric acid, tatraboric acid, and pentaboric acid, and salts thereof.

The used amount of boric acids or salts thereof may vary widely depending on the amount of minute inorganic particles and hydrophilic polymers of liquid coating compositions, but is commonly 1-60 percent by weight, and is preferably 5-40 percent by weight.

Further, it is preferable that organic hardeners such as epoxy based hardeners, aldehyde based hardeners, isocyanate based hardeners, ethyleneimino based hardeners, or melamine based hardeners are employed together with the aforementioned boric acid based hardeners.

In the present invention, in view of minimal image unevenness due to a high ink absorption rate and relatively low generation of curl due to the relatively small amount of hydrophilic polymers used, it is preferable that an ink receptive layer is a porous layer having voids.

It is possible to incorporate various additives other than the above-mentioned into the ink receptive layer of the ink-jet recording sheet of the present invention.

Of these, in order to enhance water resistance and moisture resistance after printing, preferred are cationic mordants.

Employed as cationic mordants are polymer mordants having a primary, secondary or tertiary amino group and a quaternary ammonium salt group. Of these, polymer mordants having a quaternary ammonium salt group are preferred since discoloration and degradation of lightfastness during storage are minimized, while dye mordanting capability is sufficiently high.

Preferred polymer mordants are prepared in the form of homopolymers of monomers having the aforementioned quaternary ammonium salt group and copolymers with other monomers.

Further, in the case in which minute particles such as alumina or pseudo-boehmite in which the surface charge is cationic, they may also be employed as a cationic mordant since they themselves exhibit dye fixability.

Other than those mentioned above, it is possible to incorporate various additives, known in the art, such as UV absorbers described in JP-A Nos. 57-74193, 57-87988, and 62-261476; anti-discoloring agents described in JP-A Nos. 57-74192, 57-87989, 60-72785, 61-146591, 1-95091, and 3-13376; various anionic, cationic, nonionic, and amphoteric surfactants, optical brightening agents described in JP-A Nos. 59-42993, 59-52689, 62-280069, 61-242871, and 4-219266; antifoaming agent; lubricants such as diethylene glycol; antiseptic agents, thickeners; antistatic agents; and matting agents.

When an ink receptive layer is applied onto a support, for the purpose of enhancing adhesion strength between the surface and the coating layer, it is preferable that the support is subjected to corona discharge treatment and subbing treatment.

In order to minimize curling, as well as sticking when stacked immediately after printing, and ink transfer, it is possible to provide various kinds of back layers on the side opposite the ink receptive layer of the ink-jet recording sheet of the present invention.

The constitution of the back layer varies depending on the type and thickness of the support, the constitution, and thickness of the front side, but hydrophilic binders or hydrophobic binders are commonly employed. The thickness of the back layer is customarily in the range of 0.1-10 μm.

Further, in the back layer, it is preferable that in order to improve electrostatic characteristics, antistatic agents, represented by cationic polymers, are incorporated. Further, it also preferable that the surface is roughened in order to minimize sticking to another recording sheets, improve writability as well as tracking characteristics in an ink-jet recording apparatus. For this purpose, preferably employed are minute organic or inorganic particles of a particle diameter of 2-20 μm.

The smoothness of the back layer is preferably Ra 0.4-5 μm, Rz 1-30 μm, and Rmax 2-40 μm, while glossiness is preferably 5-30 percent.

Preferably employed as coating systems of an ink receptive layer is a roll coating method, a rod bar coating method, an air knife coating method, a spray coating method, a curtain coating method, or an extrusion coating method, described U.S. Pat. No. 2,681,294, which employs a hopper.

When polyolefin resin coated paper is employed as a support, it is preferable that drying is commonly carried out in the range of 0-80° C. When the temperature exceeds 80° C., polyolefin resins become soft, whereby tracking becomes difficult, and non-uniform glossiness on the surface of the recording layer results. The preferred drying temperature is 0-70° C.

Further, it is preferable that the surface of the ink receptive layer of the present invention exhibits the characteristics below.

Friction coefficient: Obverse and reverse dynamic friction coefficients are 0.2-0.8.

White background (obverse and reverse): L*=88-96, a*= 3-+3 and, and b*=−8-+3

Opacity: 88-98 percent

The ink-jet recording sheets of the present invention are preferably employed for water-based dye ink as well as water-based pigment ink, but may also be employed for oil-based pigment ink.

Preferably employed water-based ink will now be described.

Water-based ink, as descried herein, is comprised of colorants, liquid media, and other additives. Employed as colorants may be direct dyes, acid dyes, basic dyes, reactive dyes, water-soluble dyes such as food dyes, or water-dispersible pigments which are conventionally known in ink-jet systems and commonly employed. Examples include direct dyes described in JP-A Nos. 11-116833, 10-77427, 10-60336, and 7-258982, acid dyes described in JP-A Nos. 11-315237, 11-315229, and 11-302985, basic dyes described in JP-A Nos. 9-316380 and 7-314880, reactive dyes described in JP-A Nos. 2000-85236, 11-148035, 9-67783, 9-311866, and 8-333539, water-soluble dyes described in JP-A Nos. 2000-204306, 2000-204303, 2000-177242, and 2000-38529, and water dispersible pigments described in JP-A No. 10-36729. The content of the aforesaid colorants in ink is about 0.1-about 20 percent by weight with respect to the total ink amount.

The liquid medium of water-based ink is comprised of water and water compatible solvents. Listed as various types of water compatible solvents are, for example, alcohols such methyl alcohol, isopropyl alcohol, n-butyl alcohol, tert-butyl alcohol, and isobutyl alcohol; amides such as dimethylformamide and dimethyl acetamide; ketones or ketone alcohols such as acetone and diacetone alcohol; ethers such as tetrahydrofuran and dioxane; polyalkylene glycols such as polyethylene glycol and polypropylene glycol; polyhydric alcohols such as ethylene glycol, polypropylene glycol, butylene glycol, triethylene glycol, 1,2,6-hexanetriol, thioglycol, hexylene glycol, diethylene glycol, glycerin, or triethanolamine; lower alkyl ethers of polyhydric alcohol such as ethylene glycol methyl ether, diethylene glycol methyl (or ethyl) ether, and triethylene glycol monobutyl ether.

Of such as many water-soluble organic solvents are preferred polyhydric alcohols such as diethylene glycol, triethanolamine, and glycerin, and lower alkyl ethers of polyhydric alcohols such as triethylene glycol monobutyl ether. The content of the above water compatible organic solvents is about 10-60 percent by weight with respect to the total ink.

Listed as other additives for water-based ink are pH control agents, metal sequestering agents, mildewcides, viscosity modifiers, surface tension control agents, and anticorrosive agents.

In order to enhance wettability for recording sheets, it is preferable that water-based ink liquids exhibit surface tension in the range of 25-60×10⁻³ N/m, more preferably it is in the range of 30-50×10⁻³ N/m measured at 20° C.

Specifically, when ink-jet recording sheets carry an embossed texture, the above range of surface tension is preferred due to the fact that unnatural glossiness is reduced even in cases in which a pigment ink is used for recording.

Employed as pigments usable in pigment ink may be those which are known in the art for ink-jet printing. Examples include azo pigments such as azo chelates, water-insoluble azo pigments, condensation azo pigments, or chelate azo pigments; polycyclic pigments such as phthalocyanine pigments, perylene and perylene pigments, anthraquinone based pigments, quinacridone based pigments, dioxanzine based pigments, thioindigo pigments, isoindoninone based pigments, or quinophthalone based pigments; dye lakes such as basic dye type lakes, acidic dye type lakes; organic pigments such as nitro pigments, nitroso pigments, aniline black, daylight fluorescent pigments, and inorganic pigments such as carbon black.

Further, listed as dispersing agents for pigments may be, for example, higher fatty acid salts, alkyl sulfates, alkyl ester sulfates, alkyl sulfonates, sulfosuccinates, naphthalene sulfonates, alkyl phosphates, polyoxyalkylene alkyl ethers, polyoxyethylene polyoxypropylene glycol, glycerin ester, sorbitan ester, polyoxyethylene fatty acid amides or polymer surface active agents.

Other than those described above, if desired, incorporated into the pigment ink may be various kinds of additives.

Listed as such additives may be, for example, water-soluble organic solvents (for example, propanol, hexanol, ethylene glycol, diethylene glycol, glycerin, hexanediol, and urea), surface active agents (such as anionic surface active agents, nonionic surface active agents, and fluorine based surface active agents), water-soluble polymers, polymer dispersions, antiseptics, mildewcides, viscosity modifiers, and pH control agents. Of these, water-soluble polymers are particularly preferred due to the marked enhancement of abrasion resistance after printing.

The average diameter of pigment particles is at most 300 nm, is preferably at most 200 nm, and is most preferably 150-50 nm.

### EXAMPLES

The present invention will now be specifically described with reference to examples. However, the embodiments of the present invention is not limited thereto. Incidentally, “%” in the examples refers to absolute dry % by weight unless otherwise specified.

### Example 1

Low density polyethylene at a density of 0.92 was applied onto the reverse side of photographic base paper at a basic weight of 180 g/m² to result in a thickness of 35 μm, employing an extrusion coating method. Subsequently, low density polyethylene at a density of 0.92 comprising 9.5% by weight of anatase type titanium oxide was applied onto the obverse side to result in a thickness of 26 μm, employing a melt extrusion coating method, whereby a support with a glossy surface, which was coated with polyethylene on both sides, was prepared. The glossiness of the resulting support was 35% at 60 degrees.

After applying corona discharge to the surface of the titanium oxide containing layer of the resulting support, a sublayer comprised of polyvinyl alcohol, boric acid, and surface active agents was applied onto the resulting surface so that the coated weight of polyvinyl alcohol reached 0.05 g/m².

On the other hand, a styrene/acryl based emulsion comprising minute silica particles (being a matting agent) of an average particle diameter of about 1 μm, and cationic polymers (being electrically conductive agents) in a small amount was applied onto the reverse side to result in a layer thickness of 0.5 μm, whereby a support for coating an ink receptive layer was prepared.

The Ra of the reverse surface of the support prepared as above was approximately 1.2 μm.

Subsequently, a dispersion having the composition described below was prepared for an ink receptive layer of the obverse side.

<Preparation of Titanium Oxide Dispersion 1>

Added to 90 L of an aqueous solution containing 150 g of sodium tripolyphosphate at a pH of 7.5, 500 g of polyvinyl alcohol (PVA235, manufactured by Kuraray Co., Ltd.), 150 g of a cationic polymer (P-1), and 10 g of antifoaming agent SN381, manufactured by Sun Nobco Co.), was 20 kg of titanium oxide (having an average particle diameter of 0.25 μm, W-10, manufactured by Ishihara Sangyo Kaisha Ltd.). The resulting mixture was dispersed employing a high pressure homogenizer (manufactured by Sanwa Industry Co., Ltd.). Thereafter, the total volume was brought to 100 L, whereby uniform Titanium Oxide Dispersion 1 was prepared.

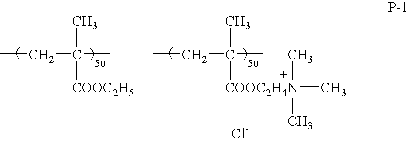

<Preparation of Silica Dispersion 1>

A solution having the composition described below was prepared.

| | | |
|---|---|---|
| Water | 71 | L |
| Boric acid | 0.27 | kg |
| Borax | 0.24 | kg |
| Ethanol | 2.2 | L |
| 25% aqueous solution of cationic polymer | 17 | L |
| (P-1) | | |
| 10% aqueous solution of an anti-discoloring | 8.5 | L |
| agent (AF1*) | | |
| Optical brightening agent (W1*) | 0.1 | L |
| Water to make | 100 | L |

Collected as minute inorganic particles was 50 kg of gas phase method silica (of an average primary particle diameter of the of about 12 nm).

Silica Dispersion 1 was prepared while dispersed employing the method described in Example 5 of JP-A No. 2002-47454.

(AF1*) HON(CH₂CH2SO₃Na)₂

(W1*) UVITEX NFW LIQUID, manufactured by Ciba Specialty Chemical

<Preparation of Silica Dispersion 2>

Silica Dispersion 2 was prepared in the same manner as Silica Dispersions 1, except that Cationic Polymer P-1 was replaced with P-2.

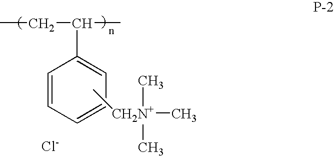

<Preparation of Liquid Coating Composition>

Each of the first, second, third, and fourth layer liquid coating compositions was prepared employing the steps below.

First Layer Liquid Coating Composition

While stirring at 40° C., the following additives were successively added to 610 ml of Silica Dispersion 1.

| | |
|---|---|
| 5% aqueous polyvinyl alcohol (PVA235, | 220 ml |
| manufactured by Kuraray Co., Ltd.) | |
| solution | |
| 5% aqueous polyvinyl alcohol (PVA245, | 80 ml |
| manufactured by Kuraray Co., Ltd.) | |
| solution | |
| Titanium Oxide Dispersion 1 | 30 ml |
| Latex emulsion (AE-803, manufactured by | 21 ml |
| Dai-ichi Kogyo Co., Ltd.) | |
| 5% aqueous surface active agent (DF1) | 1.5 ml |
| solution | |
| Pure water to make | 1000 ml |

Second Layer Liquid Coating Composition

While stirring at 40° C., the following additives were successively added to 650 ml of Silica Dispersion 1.

| | |
|---|---|
| 5% aqueous polyvinyl alcohol (PVA235, | 180 ml |
| manufactured by Kuraray Co., Ltd.) | |
| solution | |
| 5% aqueous polyvinyl alcohol (PVA245, | 80 ml |
| manufactured by Kuraray Co., Ltd.) | |
| solution | |
| Latex emulsion (AE-803, manufactured by | 15 ml |
| Dai-ichi Kogyo Co., Ltd.) | |
| Pure water to make | 1000 ml |

Third Layer Liquid Coating Composition

While stirring at 40° C., the following additives were successively added to 650 ml of Silica Dispersion 2.

| | |
|---|---|
| 5% aqueous polyvinyl alcohol (PVA235, | 180 ml |
| manufactured by Kuraray Co., Ltd.) | |
| solution | |
| 5% aqueous polyvinyl alcohol (PVA245, | 80 ml |
| manufactured by Kuraray Co., Ltd.) | |
| solution | |
| Pure water to make | 1000 ml |

Fourth Layer Liquid Coating Composition

While stirring at 40° C., the following additives were successively added to 650 ml of Silica Dispersion 2.

| | |
|---|---|
| 5% aqueous polyvinyl alcohol (PVA235, | 180 ml |
| manufactured by Kuraray Co., Ltd.) | |
| solution | |
| 5% aqueous polyvinyl alcohol (PVA245, | 80 ml |
| manufactured by Kuraray Co., Ltd.) | |
| solution | |
| Silicone dispersion (BY-22-839, manufactured | 3.5 ml |
| by Toray-Dow Corning Silicone Co., Ltd.) | |
| 50% aqueous saponin solution | 4 ml |
| 5% aqueous surface active agent (SF-1) | 6 ml |
| solution | |
| Pure water to make | 1000 ml |
| SF-1 | |
| C₁₈H₃₇N⁺(CH₃)₃Cl⁻ | |

Each of the liquid coating compositions prepared as above was subjected to two-stage filtration employing TCP10, manufactured by Toyo Roshi Co., Ltd.

All the above liquid coating compositions exhibited viscosity characteristics of 30-80 mPa·s at 40° C. and 30-100 Pa·s at 15° C.

All the liquid coating compositions prepared as above were simultaneously coated onto the obverse side of the aforementioned support in the listed order of the first layer (35 μm), the second layer (45 μm), the third layer (45 μm), and the fourth layer (40 μm). The figure in the parenthesis shows the wet layer thickness. All the liquid coating compositions at 40° C. were simultaneously coated employing a four-layer system curtain coater. Immediately after coating, the resulting coating was cooled in an 8° C. cooling zone maintained at for 20 seconds. Thereafter, it was dried at 20-30° C. and 20 percent relative humidity or less for 40 seconds; at 55° C. and 20 percent relative humidity or less for 120 seconds; and at 55° C. and 30 percent relative humidity or less for 60 seconds while blown by drying air (the layer temperature was 8-30° C. during a constant-rate drying zone and gradually increased during a falling-rate drying zone). Thereafter, it was rehumidified at 23° C. and 40-60 percent relative humidity and wound into a roll, whereby a recording sheet was prepared. The resulting recording sheet was stored at 40° C. for 5 days. Glossiness measured at 60° and Ra of the recording sheet were 41 percent and 0.34 μm, respectively.

Subsequently, the above-mentioned recording sheet was cut into A4 size, and 20 sheets were aligned and stacked in the same direction. A protective sheet (also A4 size) shown in Table 1 was placed on both sides of each stack of sheets and the resulting stack was packaged in polycarbonate resinous film. Subsequently, 20 packages packaged in the resinous film were placed in a shipping corrugated cardboard box.

Each of the packed products was stored at 50° C. for 7 days. Thereafter, the protective sheet and the outermost recording sheet of which ink receptive layer came into contact with the aforesaid protective sheet of the package, and the recording sheet from the middle of the package were collected, and whiteness, glossiness (at 60 degrees), and distinctness of image were evaluated.

White background was expressed by ΔE={(L1−L2)²+(a1−a2)²+(b1−b2)²}^{1/2}

wherein (L1, a1, b1) and (L2,a2,b2) each represent whiteness (L*, a*, b*) of the surface of the ink receptive layer of the recording sheet from the middle of 20 sheets and of the ink receptive layer which came into contact with the protective sheet, and ΔE represents color difference of the white background between those.

Further, the distinctness of image was represented by the C value specified in JIS K 7105, which is expressed by

C={(M−m)/(M+m)}×100

wherein C represents distinctness of image (percent), M represents the maximum light transmission value of a transparent portion, and m represents the minimum value of an opaque portion.

Table 1 shows the results.

TABLE 1

| | Protective Sheet | | | | | | | | |
|---|---|---|---|---|---|---|---|---|---|
| | | | Thickness | | | | | | |
| | | | of | | White | Glossiness | | C Value | |
| | | Waterproofing | Resinous | | Background | | Middle | | Middle |
| | Substrate | Resin | Layer | Ra | ΔE | Outermost | Portion | Outermost | Portion |
| 1 (Comp.) | 200 μm F.Q.P | — | — | — | 2.21 | 37% | 41% | 50% | 58% |
| 2 (Comp.) | 200 μm R.P. | — | — | — | 5.02 | 35% | 41% | 47% | 58% |
| 3 (Comp.) | 150 μm R.P. | PE | 10 μm | 0.11 μm | 1.21 | 44% | 41% | 67% | 58% |
| 4 (Inv.) | 150 μm R.P. | PE | 10 μm | 0.42 μm | 1.10 | 42% | 41% | 60% | 58% |
| 5 (Inv.) | 150 μm R.P. | PE | 10 μm | 0.81 μm | 1.15 | 41% | 41% | 58% | 58% |
| 6 (Inv.) | 150 μm R.P. | PE | 5 μm | 1.3 μm | 1.30 | 41% | 41% | 59% | 58% |
| 7 (Inv.) | 150 μm R.P. | PE | 10 μm | 1.6 μm | 1.17 | 41% | 41% | 58% | 58% |
| 8 (Inv.) | 150 μm R.P. | PE | 10 μm | 2.4 μm | 1.10 | 41% | 41% | 56% | 58% |
| 9 (Inv.) | 150 μm R.P. | PE | 10 μm | 2.7 μm | 0.95 | 39% | 41% | 53% | 58% |
| 10 (Comp.) | 150 μm R.P. | PE | 10 μm | 4.2 μm | 1.03 | 38% | 41% | 47% | 58% |
| 11 (Inv.) | 150 μm R.P. | PP | 10 μm | 0.45 μm | 1.14 | 41% | 41% | 59% | 58% |

Comp.: Comparative sample
Inv.: Inventive sample
PE: polyethylene
PP: polypropylene
F.Q.P.: Fine-quality paper
R.P.: Recycled paper

Based on the results of Table 1, it was noted that when the protective sheets which were treated with waterproofing resins were employed, variation of the white background during storage was retarded, while when protective sheets of a surface roughness Ra of less than 0.2 μl and more than 3 μm, were employed, the difference in glossiness and the distinctness of image between the outermost and middle portion recording sheets increased due to storage.

### Example 2

An ink-jet recording sheet was prepared in the same manner as Example 1, except that the support of the recording sheet was replaced with a support which was silk-embossed. The 60-degree glossiness and Ra of the surface of the resulting ink receptive layer were 28 percent and 1.25 μm, respectively.

Various protective sheets were overlapped in the same manner as in Example 1 and evaluation was also carried out in the same manner as Example 1.

Table 2 shows these results.

TABLE 2

| | Protective Sheet | | | | | | | | |
|---|---|---|---|---|---|---|---|---|---|
| | | | Thickness | | | | | | |
| | Substrate | | of | | White | Glossiness | | C Value | |
| | (Recycled | Waterproofing | Resinous | | Background | | Middle | | Middle |
| | paper) | Resin | Layer | Ra | ΔE | Outermost | Portion | Outermost | Portion |
| 2 (Comp.) | 200 μm | — | — | — | 4.42 | 23% | 28% | 20% | 25% |
| 3 (Comp.) | 150 μm | PE | 10 μm | 0.11 μm | 1.01 | 33% | 28% | 30% | 25% |
| 4 (Inv.) | 150 μm | PE | 10 μm | 0.42 μm | 0.92 | 29% | 28% | 25% | 25% |
| 7 (Inv.) | 150 μm | PE | 10 μm | 1.6 μm | 0.89 | 28% | 28% | 25% | 25% |
| 9 (Inv.) | 150 μm | PE | 10 μm | 2.7 μm | 0.83 | 27% | 28% | 24% | 25% |
| 10 (Comp.) | 150 μm | PE | 10 μm | 4.2 μm | 0.84 | 24% | 28% | 20% | 25% |

Comp.: Comparative sample
Inv.: Inventive sample
PE: polyethylene
PP: polypropylene

When the protective sheet at the surface roughness of the present invention is employed in the same manner as Example 1, it is possible to retard the variation of the white background of the outermost recording sheet while avoiding variation of glossiness and distinctness of image due to storage.

### Example 3

Packages prepared in Example 2 were stored at 50° C. for seven days. Thereafter, the protective sheet and the outermost recording sheet of which ink receptive layer came into contact with the aforesaid protective sheet of the package, and a recording sheet from the middle stack in the package at the bottom of the corrugated cardboard box were loaded and printed employing a water-based pigment ink-jet printer. The degree of glare of the resulting prints was visually evaluated. No perceived glare was ranked as 5 and the maximum perceived glare was ranked as 1. The resulting glare was relatively evaluated in a range of 1-5.

Table 3 shows the results.

TABLE 3

| | Protective Sheet | | | | | |
|---|---|---|---|---|---|---|
| | Substrate | | Thickness | | Glare | |
| Sample | (Recycled | Waterproofing | of Resinous | | | Middle |
| No. | paper) | Resin | Layer | Ra | Outermost | Portion |
| 2 (Comp.) | 200 μm | — | — | — | 4 | 4 |
| 3 (Comp.) | 150 μm | PE | 10 μm | 0.11 μm | 1 | 4 |
| 4 (Inv.) | 150 μm | PE | 10 μm | 0.42 μm | 4 | 4 |
| 7 (Inv.) | 150 μm | PE | 10 μm | 1.6 μm | 4 | 4 |
| 9 (Inv.) | 150 μm | PE | 10 μm | 2.7 μm | 4 | 4 |
| 10 (Comp.) | 150 μm | PE | 10 μm | 4.2 μm | 3 | 4 |

Comp.: Comparative sample,
Inv.: Inventive sample

When a protective sheet of the present invention was employed, it was noted that the outermost recording sheet resulted in no variation of perceived glare when printed employing the pigment ink even after storage.

The white background and the glossiness of the surface of the ink receptive layer of the outermost ink-jet recording sheet which was in contact with a protective sheet resulted in a minimal variation even during extended storage. Further, when printed employing pigment ink, variation of perceived glare decreased.

What is claimed is:

1. A package comprising:
(i) a plurality of ink-jet recording sheets stacked one on top of the other, wherein each of said ink-jet recording sheet has an ink receptive layer as a top layer;
(ii) a protective sheet which is placed on a top ink-jet recording sheet of said plurality of ink-jet recording sheet, said protective sheet having a water-resistant surface, said water-resistant surface facing said ink receptive layer of said top ink-jet recording sheet,
wherein said water-resistant surface has a center-line mean roughness (Ra) of 0.2-3 μm measured based on JIS B 0601 with a reference length of 2.5 mm and a cut-off value of 0.8 mm; and
(iii) an envelop sheet surrounding said plurality of ink-jet recording sheets and said protective sheet thereby forming said package.

2. The package of claim 1, wherein the water-resistant surface of the protective sheet is made by applying a surface layer forming composition containing a water-resistant resin on the paper support or laminating a film containing the water-resistant resin on the paper support.

3. The package of claim 2, wherein the water-resistant resin is a polyolefin resin and the surface layer has a thickness of 2 to 50 μm.

4. The package of claim 1, wherein the center-line mean roughness (Ra) of the water-resistant surface of the protective sheet and an center-line mean roughness (Ra′) of a surface of the ink receptive layer of the ink-jet recording sheet satisfy the following formula:

|Ra−Ra′|≦1 μm

5. The package of claim 1, wherein the ink-jet recording sheet comprises:
(i) a resin coated paper having on both sides thereof a polyolefin resin layer; and
(ii) an ink receptive layer containing inorganic microparticles and a hydrophilic polymer, the ink receptive layer being provided on one side of the polyolefin resin layer.

6. A method of forming an image comprising a step of:
ejecting droplets of ink on an ink-jet recording sheet with an ink-jet printer, wherein the ink-jet recording sheet is packed in the package of claim 1.

7. The method of forming an image of claim 6, wherein the ink is a water-based pigment ink.
